(19) United States
(12) Patent Application Publication
(10) Pub. No.: US 2026/0168404 A1
(43) Pub. Date: Jun. 18, 2026

(54) SYSTEMS AND METHODS FOR CLEANING A GAS TURBINE ENGINE

(71) Applicant: General Electric Company, Evendale, OH (US)

(72) Inventors: David Raju Yamarthi, Bangalore (IN); Paul Mathew, Bangalore (IN); Ravindra Shankar Ganiger, Bangalore (IN); Krishna Ramadurai, Bangalore (IN); Kirti Arvind Petkar, Bangalore (IN); Andrew Crispin Graham, Badminton (GB)

(21) Appl. No.: 19/416,192

(22) Filed: Dec. 11, 2025

(30) Foreign Application Priority Data
Dec. 13, 2024 (IN) 202411098688

(51) Int. Cl. F01D 25/00; B08B 7/00; B08B 7/02

(52) U.S. Cl. CPC F01D 25/002; B08B 7/0042; B08B 7/026

(57) ABSTRACT

Provided herein are methods for cleaning a component of a gas turbine engine. The methods described herein subject the component to at least one transient thermal cycle and then clean the component to remove at least a portion of the contaminant deposit from the component. During the at least one transient thermal cycle, the surface temperature of the component changes by at least 293 degrees Kelvin (K). In some embodiments, the surface temperature of the component changes by a rate of at least 100 degrees Kevin per second or, in some embodiments, by a rate of at least 100,000 degrees Kelvin per second within the transient thermal cycle. After exposing the component to the at least one transient thermal cycle, the component is cleaned to remove at least a portion of a contaminant deposit.

### CROSS REFERENCE TO RELATED APPLICATION

This application claims priority to Indian Provisional Application No. 202411098688 filed Dec. 13, 2024, which is incorporated herein by reference in its entirety.

### TECHNICAL FIELD

These teachings relate generally to systems and methods for cleaning a gas turbine engine.

### BACKGROUND

Gas turbine engines are used in various applications, including aviation and power generation. Over time, contaminants or hardened deposits can accumulate on the components of these engines, affecting their performance and efficiency. Traditional cleaning methods, such as chemical cleaning, can be time-consuming, costly, and may not effectively remove all contaminants. Thus, an improved method of cleaning a gas turbine engine may be desirable.

### BRIEF DESCRIPTION OF DRAWINGS

Various needs are at least partially met through provision of the systems and methods for cleaning a gas turbine engine described in the following detailed description, particularly when studied in conjunction with the drawings. A full and enabling disclosure of the aspects of the present description, including the best mode thereof, directed to one of ordinary skill in the art, is set forth in the specification, which refers to the appended figures, in which:

FIG. 1 comprises a schematic diagram of a wash system operable with a gas turbine engine in accordance with various embodiments of these teachings;

FIG. 2 comprises a schematic diagram of a cross-section of a portion of a gas turbine engine in accordance with various embodiments of these teachings;

FIG. 3 comprises a schematic diagram of a device used to clean an internal surface of a gas turbine engine in accordance with various embodiments of these teachings;

FIG. 4 comprises a flow diagram of a method for cleaning a gas turbine engine in accordance with various embodiments of these teachings;

FIG. 5 comprises a flow diagram of a method for cleaning a gas turbine engine in accordance with various embodiments of these teachings;

FIG. 6 comprises a flow diagram of a method for cleaning a gas turbine engine in accordance with various embodiments of these teachings;

FIG. 7A comprises a top view of a device that can be used to clean a component and/or subject the component to at least one transient thermal cycle, according to some embodiments;

FIG. 7B comprises a side view of the device of FIG. 7A;

FIG. 7C comprises a schematic diagram of various components of the device of FIGS. 7A and 7B, according to some embodiments;

FIG. 7D comprises a schematic diagram of additional components of the device of FIGS. 7A and 7B, according to some embodiments; and

FIG. 8 comprises a graph representing a rate of change of temperature of a component with a contaminant deposit formed thereon during multiple transient thermal cycles, according to some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present teachings. Also, common but well-understood elements that are useful or necessary in a commercially feasible embodiment are often not depicted in order to facilitate a less obstructed view of these various embodiments of the present teachings. Certain actions and/or steps may be described or depicted in a particular order of occurrence while those skilled in the art will understand that such specificity with respect to sequence is not actually required.

### DETAILED DESCRIPTION

The methods of cleaning a gas turbine engine described herein provide approaches for removing contaminants from engine components, for example, hardened deposits on a component of a turbine gas engine. More specifically, the methods described subject the component to at least one transient thermal cycle to weaken the adherence of the contaminants deposited on the component.

During operation, a substantial amount of air is ingested by such gas turbine engines. However, air may contain foreign particles such as dust. A majority of the foreign particles will follow a gas path through the engine and exit with the exhaust gases. However, at least a certain amount of these particles may stick to and form hardened deposits on certain components within the gas turbine engine. For example, impact and heat may cause the dust to bond to uncoated blades in the compressor, while within the hot section such as the combustor and high pressure turbine, the dust may melt into a corrosive slag-like material such as calcium magnesium aluminosilicate (CMAS) compounds and infiltrate into the thermal or environmental barrier coatings, potentially changing aerodynamic and/or thermal properties of the engine and reducing engine performance.

Traditionally, in order to remove such foreign particles from within the gas path of the gas turbine engine, a cleaning fluid may be directed into the gas path of the gas turbine engine to remove the contaminants. For example, foam can be introduced into the gas turbine engine and pass through the gas turbine engine to remove contaminants from inside. The foam carries or transports the contaminants out of the gas turbine engine. However, a typical wash cycle for foam cleaning systems may last for several hours and typically involves cycle times of up to or greater than four hours to properly clean the turbine engine.

Accordingly, the methods described herein subject the component to at least one transient thermal cycle and then clean the component to remove at least a portion of the contaminant deposit from the component. The at least one transient thermal cycle induces a thermal shock or a change in temperature of the contaminant deposit, and in some examples, the component. The rate of change of the temperature during the at least one thermal cycle and/or the thermal gradient formed due to the rapid temperature change induce a differential strain to weaken the adhesion or remove the contaminant deposit from the component.

In some embodiments, such as when the transient thermal cycle is accomplished via a fluid medium and/or a non-laser thermal energy source, the at least one transient thermal cycles include thermal transients with longer durations (e.g., greater than about 50 milliseconds (ms), greater than about 100 ms, greater than about 1 second, or greater than about 1 minute) and lower power densities (e.g., less than about 1 kilowatt (kW), less than about 500 watts (W), less than about 100 W, or less than about 50 W) to induce a temperature rise in the contaminant deposit which exploits the differences in the coefficient of thermal expansion between the component and the contaminant deposit. The at least one transient thermal cycle may cause a thermal shock. During the at least one transient thermal cycle, the surface temperature of the component may change by at least 293 degrees Kelvin (K). The change in temperature may be a result of the thermal cycling between a thermal energy source and a cooling medium, or an initial engine core temperature and the cooling medium, such as room temperature water. In some embodiments, the surface temperature of the component changes by a rate in the range of about 100 to about 100,000 K per second, in the range of about 100 K to about 10,000 K per second, or in the range of about 100 K to about 1,000 K per second. In some embodiments, the surface temperature of the component changes by a rate of at least about 100 K per second, for example, when a fluid or non-laser thermal energy source or fluid medium is employed. In some embodiments, the surface temperature of the component changes by a rate of at least 100 K per second, at least about 300 K per second, at least about 400 K per second, at least about 500 K per second, at least about 600 K per second, at least about 700 K per second, at least about 800 K per second, at least about 900 K per second, at least about 1,000 K per second, or at least 10,000 K per second, within the transient thermal cycle when a non-laser thermal energy source or fluid medium is employed. The change in temperature causes a differential expansion or contraction within the contaminant, and between the contaminant deposit and the component (e.g., the underlying substrate), leading to internal stresses that weaken the agglomerated contaminant and the bond between the contaminant deposit and the component.

In some embodiments, such as when the transient thermal cycle is accomplished via a laser, the one or more transient thermal cycles include intense thermal transient pulses with shorter durations (e.g., in the range of about 1 ms to about 50ms) and higher power densities (e.g., in the range of about 100 W to about 10 kW) to include a rapid temperature gradient for localized heating and significant thermal stress. The transient thermal cycle causes a differential strain due to the differential expansion or contraction between the contaminant deposit and the component to exploit the adherence at cleavage planes between the contaminant deposit and the component. In this manner, the adherence of the contaminant deposit to the component is weakened. As such, the efficiency of the cleaning cycle is increased and the time of the cleaning cycle is reduced, thereby reducing the amount of time for returning the gas turbine engine to service.

In some embodiments, the method includes subjecting the component to two or more transient thermal cycles. For example, the component is exposed to a hot cycle, followed by a cold cycle. Though, it is contemplated that the hot cycle and the cold cycle may be performed in any suitable order. In some embodiments, the sequential hot, cold cycles are repeated several times prior to initiating the cleaning cycle.

In some embodiments, the hot cycle includes a thermal energy source in the temperature range of about 323 K to 1,000 K, and in particular, the thermal energy source includes at least one of hot air, hot water, steam or a laser. In one example, when the thermal energy source is hot air, the temperature of the thermal energy source may be about 973 K or greater. In another example, when the thermal energy source is hot water or steam, the temperature of the thermal energy source may be in the range of about 323 K to about 373 K.

In some embodiments, the cold cycle includes a cooling medium in the temperature range of about 77 K to 300 K, and in particular, the cooling medium includes at least one of cold air, water, ice, dry ice, liquid nitrogen, or a refrigerant coolant. In one example, when the cooling medium is liquid nitrogen, the temperature of the cooling medium may be about 77 K. In another example, when the cooling medium is dry ice, the temperature of the cooling medium may be about 195 K.

In some embodiments, the hot cycle includes use of a laser. In some approaches, the laser has a power in the range of 100 W to 10 kW and operates at a pulse repetition frequency in the range of about 1 pulse per second to about 50 pulses per second. The laser comprises a laser assembly including a probe for directing a laser beam to a target. The probe extends from a proximal end portion that is coupled to a laser source to a distal end portion that focuses the laser on the target. The distal end portion of the probe includes a lens for adjusting the laser beam and a mirror for directing the laser beam towards the target. In some embodiments, the distal end further includes a galvanometer operatively coupled to the mirror for adjusting an angle of the laser beam.

In some embodiments, the method includes determining a characteristic of a cleaning fluid effluent stream. The cleaning fluid effluent stream includes at least a portion of the cleaning fluid that exited the engine core following the cleaning step. The determined characteristic is used to determine a number of additional transient thermal cycles to be performed on the engine. The determined characteristic can also be used to determine whether cleaning of the component is complete.

The terms and expressions used herein have the ordinary technical meaning as is accorded to such terms and expressions by persons skilled in the technical field as set forth above except where different specific meanings have otherwise been set forth herein. The word “or” when used herein shall be interpreted as having a disjunctive construction rather than a conjunctive construction unless otherwise specifically indicated. The terms “coupled,” “fixed,” “attached to,” and the like refer to both direct coupling, fixing, or attaching, as well as indirect coupling, fixing, or attaching through one or more intermediate components or features, unless otherwise specified herein.

The singular forms “a”, “an”, and “the” include plural references unless the context clearly dictates otherwise.

As used herein, transient thermal cycle” refers to process of exposing a material or structure to energy source to induce a rapid temperature change of the material or structure. For example, the temperature change may be in the range of about 195 K to about 373 K or greater. It is generally contemplated that the temperature change during one or more transient thermal cycles is greater than a magnitude of temperature of a turbine gas engine during normal operation. As used herein, “rapid temperature change” refers to a rate of change of a temperature or a formation of a temperature gradient during the transient thermal cycle to induce differential thermal expansion and exploit weak spots in the adhesion between the dust and the component surface. In some examples, such as where a fluid media is used to achieve a transient thermal cycle, a rapid temperature change may be a rate of change of a temperature of at least 100 K per second. In other examples, such as where a laser is used to achieve a transient thermal cycle, a rapid temperature change may be a rate of change of a temperature of at least 100,000 K per second. In some aspects, the transient thermal cycle occurs when the engine is off or shutdown. The transient thermal cycle may expose the material or structure to thermal shock.

As used herein throughout the specification and claims, range limitations are combined and interchanged, such ranges are identified and include all the sub-ranges contained therein unless context or language indicates otherwise. For example, all ranges disclosed herein are inclusive of the endpoints, and the endpoints are independently combinable with each other.

Approximating language, as used herein throughout the specification and claims, is applied to modify any quantitative representation that could permissibly vary without resulting in a change in the basic function to which it is related. Accordingly, a value modified by a term or terms such as “about”, “approximately”, and “substantially”, are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin.

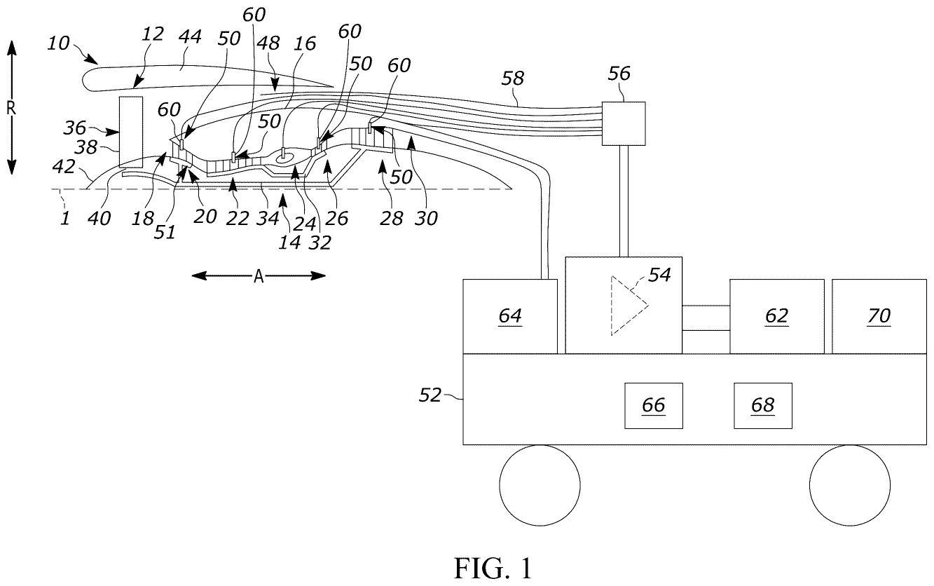

The foregoing and other benefits may become clearer upon making a thorough review and study of the following detailed description. Referring now to the drawings, and in particular to FIG. 1, an illustrative wash system 52 that is compatible with many of these teachings will now be presented.

Turning to the figures, FIG. 1 illustrates an exemplary wash system 52 operable with an engine 10. The engine 10 can be cleaned using the approaches described herein. In some embodiments, as described herein, the engine 10 is subjected to at least one or, in some aspects, two or more transient thermal cycles before cleaning the engine via the wash system 52. In some approaches, the wash system 52 or portions thereof can be used to expose the engine 10 to a transient thermal cycle. In some approaches, other equipment and/or systems may be coupled to the engine 10 to expose the engine 10 to a transient thermal cycle. The engine 10 may be exposed or subjected to the transient thermal cycles when the engine is off or shutdown. In some aspects, a surface temperature of a component of the engine 10 changed by at least 293 degrees kelvin (K) within a transient thermal cycle. Such temperature changes may weaken contaminant deposits present on the surface of component to facilitate contaminant removal.

The engine 10 is depicted as a turbofan engine, which is a type of gas turbine engine, and is referred to herein as engine 10. The engine 10 defines an axial direction A (extending parallel to a longitudinal centerline 1 that is provided for reference) and a radial direction R. The engine 10 includes a fan section 12 and a turbine engine 14 disposed downstream from the fan section 12. The turbine engine 14 generally includes a substantially tubular outer casing 16 that defines an annular inlet 18. The outer casing 16 encases, in serial flow, a compressor section including a low pressure (LP) compressor 20, a high pressure (HP) compressor 22, a combustor section 24, a turbine section including a high pressure (HP) turbine 26 and a low pressure (LP) turbine 28, and an exhaust nozzle section 30. A first, high pressure (HP) shaft 32 drivingly connects the HP turbine 26 to the HP compressor 22. A second, low pressure (LP) shaft 34 drivingly connects the LP turbine 28 to the LP compressor 20. The compressor section (e.g., the LP compressor 20 and HP compressor 22), the combustor section 24, and the turbine section (e.g., the HP turbine 26, LP turbine 28) together define an engine core 51 that extends from the annular inlet 18 through the LP compressor 20, the HP compressor 22, the combustor section 24, the HP turbine 26, the LP turbine 28, and the exhaust nozzle section 30.

The fan section 12 includes a fan 36 having a plurality of fan blades 38 coupled to a disk 40 in a spaced apart manner. The fan blades 38 extend outward from the disk 40 generally along the radial direction R. The disk 40 is covered by a rotatable front hub 42 that is aerodynamically contoured to promote a flow through the plurality of fan blades 38. Additionally, the fan section 12 includes an annular fan casing or outer nacelle 44 that circumferentially surrounds the fan 36 and/or at least a portion of the turbine engine 14. The nacelle 44 is supported relative to the turbine engine 14 by a plurality of circumferentially spaced guide vanes (not shown). A downstream section of the nacelle 44 extends over an outer portion of the turbine engine 14 so as to define a bypass passage 48 therebetween.

The fan blades 38, the disk 40, and the front hub 42 are rotatable together about the longitudinal centerline 1 directly by the LP shaft 34. However, in other embodiments the engine 10 may additionally include a reduction gearbox for driving the fan 36 at a reduced rotational speed relative to the LP shaft 34.

The engine 10 defines at least one access port 50. In some examples, the access port(s) 50 are a borescope opening that may allow for inspection of the engine 10 between operations and may be open or into the core air flow path of the engine 10. The access port(s) 50 are defined in the LP compressor 20, the HP compressor 22, a combustion chamber of the combustor section 24, the HP turbine 26, and the LP turbine 28. The access port(s) 50 may allow for inspection of the turbine engine 10, for example, to allow for inspection or servicing of one or more blades, nozzles, combustion liners, etc. of the engine 10 between operations. During normal operations, the access port(s) 50 may be plugged such that the access port(s) 50 do not affect operation of the engine 10.

In normal operation, environmental dust may deposit in the engine core 51 throughout a length of the gas flowpath within the engine 10. The range of internal temperatures of the engine 10 during operation may cause some dust to be baked onto components of the engine core 51 while in hotter locations such as the HP turbine 26 the dust can melt and attach more firmly to components, including by infiltration into barrier coatings. Some coatings, including coatings with specific chemistries may be used to reduce the accumulation, or to react with the dust in order to serve as protective and/or sacrificial layers on the components in the engine core 51. In some aspects, these coatings are designed to reduce the adhesion between the contaminant and the coating, and it is the weak interface between the contaminant and coating which may be described as a cleavage layer or cleavage plane between the contaminant and the component. In some forms, a weak cleavage plane may exist even without the use of a special coating.

In FIG. 1, the engine 10 is depicted schematically as being cleaned by a wash system 52. The wash system 52 may be any suitable wash system for the cleaning of gas turbine engines or turbines generally. In the exemplary embodiment depicted in FIG. 1, the wash system 52 is a wash cart. The wash system 52 can use water, air, inert gas, chemicals, or combinations thereof to clean the engine 10. In some embodiments, the wash system 52 is a foam washing system that generates a foam, for example, by aerating a flow of cleaning fluid. The wash system 52 includes a storage tank 62 for storing a cleaning fluid, and a pump 54 fluidly connected to the storage tank 62 to deliver the cleaning fluid through at least one delivery conduit 58. The wash system 52 may include a distribution manifold 56 for selectively distributing the cleaning fluid through the delivery conduit(s) 58 to a respective access(s) port 50. Additionally, the wash system 52 includes a waste container 64 for cleaning fluid effluent collection. An effluent line 61 is coupled to the waste container 64 for delivering cleaning fluid effluent from the engine 10 to the waste container 64. In some embodiments, the waste container 64 may be located on a separate wash cart or platform. Further, the wash system 52 may include an air source 66 and a power source 68. One or more sensors 63 can be coupled to the effluent line 61 and/or the waste container 64 to measure the characteristics of the cleaning fluid effluent stream. The sensor(s) 63 can be configured to measure at least one of a color, a density, a pH value, a turbidity, a level of total dissolved solids (TDS), a salinity, an electrical characteristic such as a conductivity or a resistivity, or a concentration value for the cleaning fluid effluent stream.

As shown, the delivery conduit(s) 58 are shown coupled to and in fluid communication with the access port(s) 50. As noted above, the engine 10 includes the outer nacelle 44 which defines the bypass passage 48. In the embodiment depicted, the delivery conduit(s) 58 extends from an aft end of the engine 10, through the bypass passage 48 to the access port(s) 50. A delivery nozzle(s) 60 is coupled to an end of the delivery conduit(s) 58 proximal the engine 10 and is inserted in the access port(s) 50. With such a configuration the wash system 52 may operate without having to remove one or more portions of the fan section 12.

It should be appreciated, however, that the exemplary engine 10 depicted in FIG. 1 is by way of example only, and that in other exemplary embodiments, aspects of the present disclosure may additionally, or alternatively, be applied to any other suitable gas turbine engine. For example, in other exemplary embodiments, the engine 10 may instead be any other suitable aeronautical gas turbine engine, such as a turbojet engine, turboshaft engine, turboprop engine, etc. Additionally, in still other exemplary embodiments, the exemplary engine 10 may include or be operably connected to any other suitable accessory systems. Additionally, or alternatively, the exemplary engine 10 may not include or be operably connected to one or more of the accessory systems discussed above.

It is contemplated that the wash system 52 can also be equipped with equipment, tanks, materials, etc. that are used to expose the engine 10 to a transient thermal cycle in accordance with one or more of the embodiments described herein. For example, as illustrated, the wash system 52 includes a second storage tank 70 holding a medium (e.g., dry ice, water, ice, liquid nitrogen, a refrigerant coolant, hot water, hot air, steam, inert gas, etc.) that can be used to heat or cool the engine 10 in one or more of a hot cycle or a cold cycle. In some approaches, the medium stored in the second storage tank 70 is delivered to the engine via one or more of the delivery conduit(s) 58 to expose the engine 10 to a transient thermal cycle.

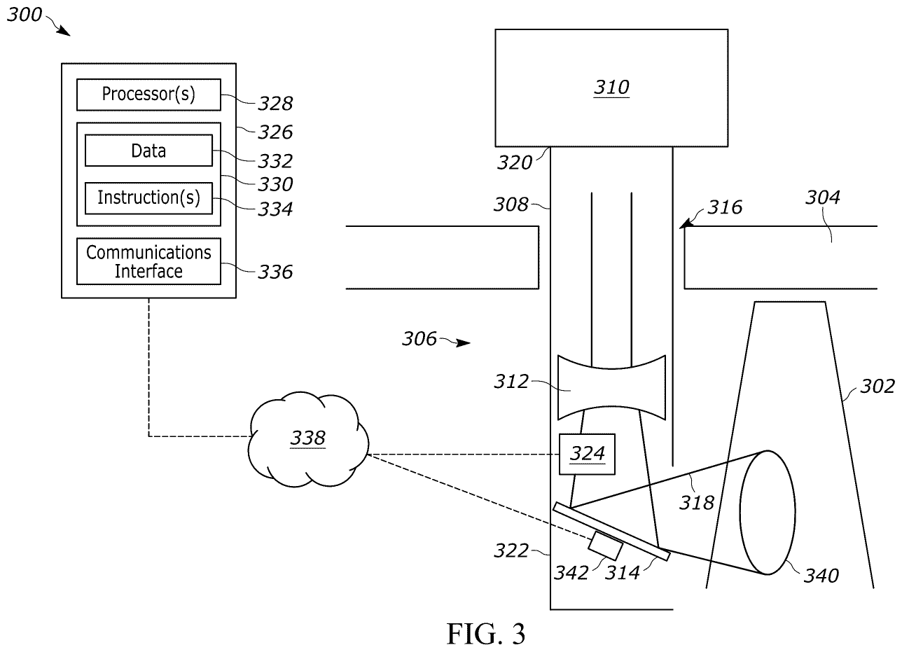

The illustrated wash system 52 generally relates to a wet process involving a liquid or a foam washing medium, though, it is contemplated that the wash systems and equipment used to clean the engine and/or expose the engine 10 to a transient thermal cycle as described herein are not limited to such systems or equipment. In some examples, the systems used to clean the engine 10 and/or expose the engine 10 to a transient thermal cycle can include, without limitation, a water wash system, a foam wash system, an abrasive media cleaning system, dry ice (carbon dioxide) blasting system, a frozen liquid media cleaning system, a laser ablative cleaning system, and the like. In some examples, engine cleaning and/or a transient thermal cycle is achieved using a dry ice blasting system that delivers solid pellets driven by compressed air or an inert gas. The dry ice pellets can be delivered into the engine 10 via an access port (e.g., a borescope inspection port or an injection port). In some examples, a transient thermal cycle is achieved using a laser assembly, such as the laser assembly 306 shown and described with reference to FIG. 3. In some examples, a transient thermal cycle is achieved using an induction coil, for example a movable induction coil, that is inserted through an access port.

It is also contemplated that separate equipment or systems, that are not part of a wash system, can be coupled to the engine to expose the engine 10 to a transient thermal cycle before a cleaning operation. Such equipment or systems may utilize different delivery conduits to the access openings.

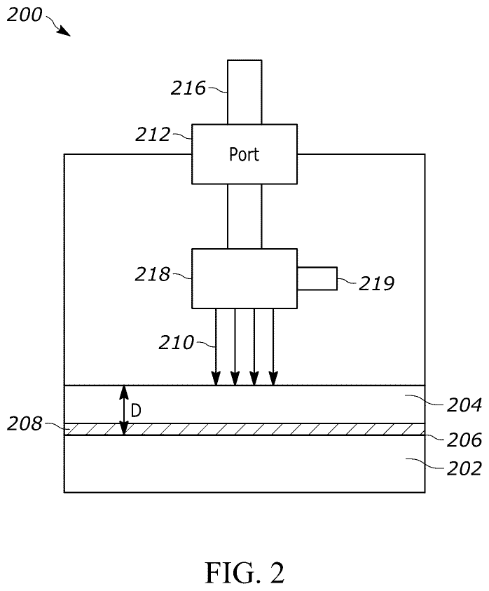

Referring to FIG. 2, a schematic diagram shows a cross-section of a portion of a gas turbine engine 200 in accordance with various aspects of the disclosure. In some embodiments, the engine 200 corresponds to the engine 10 of FIG. 1. The gas turbine engine 200 includes a component 202 and one or more access ports 212 that provide access to the component 202. The component 202 can be any component of the gas turbine engine 200 and, in some embodiments, is a component of the engine core (e.g., the engine core 51 of FIG. 1) including but not limited to a component of the compressor, the combustor or combustion chamber, of the turbine.

The component 202 may accumulate a contaminant deposit 204 during operation of the gas turbine engine 200. As shown in FIG. 2, a contaminant deposit 204 having a thickness D is provided or formed on a top surface 206 of the component 202. The contaminant deposit 204 can include, for example, coked hydrocarbons, dirt, dust, and/to other hardened deposits found in operating environments. A cleavage plane 208 is provided at the interface between the component 202 and the contaminant deposit 204. As used herein, the cleavage plane refers to a virtual plane or zone between the component 202 and the contaminant deposit 204, and more specifically, the cleavage plane 208 may be characterized by a plane or zone of reduced bonding strength.

To remove the contaminant deposit 204, the component 202 is subjected to one or more transient thermal cycles. A surface temperature of the component 202 cam change by at least 293 degrees kelvin (K) within a transient thermal cycle. As will be appreciated, such surface temperature changes induced by the transient thermal cycle stress the contaminant deposit 204, thereby weakening the contaminant deposit 204 for removal. It is generally contemplated that the parameters of the transient thermal cycle are selected to facilitate the weakening and removal of the contaminant deposit 204 without inducing damage to the component 202.

Further, it is generally contemplated that if the contaminant deposit 204 is comprised of desert sand dust, it is desirable to maintain the contaminant below a temperature of about 1123 K during the one or more transient thermal cycles to avoid fusing the contaminant deposit 204 into a more integral solid. In addition, if the contaminant is an already fused calcium magnesium aluminosilicate (CMAS), the temperature may be raised above this limit (i.e., 1,123 K) based on the thickness D of the contaminant deposit 204. It will be appreciated that pulsed laser heating may raise the surface temperature of the contaminant deposit 204 to about 1,773 K or higher without damaging the component 202. In one example, pulsed laser heating is used during the one or more transient thermal temperatures to raise the surface temperature of a 0.1 millimeter (mm) thick CMAS deposit to about 1,773 K while maintaining the component 202 (e.g., the substrate) temperature rise to less than 473 K to create a substantial thermal gradient. It will be appreciated that, in some examples, high temperatures of 1,773 K may not be sufficient to vaporize or directly ablate the contaminant deposit 204 or the component 202. Instead, in some approaches, the one or more transient thermal cycles cause defects and cracks within the contaminant deposit 204, while protecting any exposed substrate from damage in the event of direct exposure to the laser beam.

As shown in FIG. 2, the component 202 and the contaminant deposit 204 are exposed to a medium 210 introduced through the one or more access ports 212. The one or more access ports 212 may be borescope ports. As a result, a surface temperature of the component 202 may change by at least about 100 K per second in some embodiments. In some embodiments, the surface temperature of the component 202 changes by a rate of at least 100,000 K per second within the transient thermal cycle. The sudden change in temperature, such as rapid quenching or rapid heating, during the one or more transient thermal cycles leads to a differential thermal expansion or contraction and, in some aspects, the spallation of the contaminant deposit 204. The transient thermal cycle may also induce a large temperature gradient over the thickness D of the contaminant deposit 204. For example, when a laser is used, a temperature gradient in the range of about 1,000 K per millimeter to about 50,000 K per millimeter within the contaminant deposit adjacent to the component can be formed within the transient thermal cycle. In some forms, the medium 210 is a cooling medium in the temperature range of about 77 K to 300 K, and in particular, the cooling medium includes at least one of cold air, water, ice, dry ice, liquid nitrogen, or a refrigerant coolant. In other forms, the medium 210 includes a thermal energy source in the temperature range of about 323 K to 1,000 K, and in particular, the thermal energy source includes at least one of hot air, hot water, steam or a laser.

Additionally or alternatively, the one or more transient thermal cycles may induce a rapid temperature change of component 202 and the contaminant deposit 204. As a result, a large thermal gradient is formed through the contaminant deposit 204 over the thickness D. The resulting thermal gradient causes a differential expansion or contraction between the component 202 and the contaminant deposit 204. The differential expansion or contraction between the component 202 and the contaminant deposit 204 causes a differential strain in the cleavage plane 208 to facilitate the detachment of the contaminant deposit 204. It is generally contemplated that the coefficient of thermal expansion (CTE) of the component 202 and the contaminant deposit 204 may be the same or different.

In some embodiments, the component 202 and the contaminant deposit 204 are exposed to a medium 210 through a device 218 to a borescope probe 216 inserted through the one or more access ports 212. In some aspects, the device 218 includes a delivery nozzle. For example, the component 202 and the contaminant deposit 204 are exposed to a medium 210 through a delivery nozzle, such as delivery nozzle 60 shown in FIG. 1, via a delivery conduit(s), such as delivery conduit(s) 58 shown in FIG. 1. In some embodiments, the wash system 52 includes the second storage tank 70 holding the medium 210 (e.g., dry ice, water, ice, liquid nitrogen, a refrigerant coolant, hot water, hot air, steam, inert gas, etc.). The second storage tank 70 may be operatively coupled to the pump 54 shown in FIG. 1 or a compressor to deliver the medium 210 to the delivery nozzle(s) 60 via the delivery conduit(s) 58. In some aspects, the device 218 includes a laser. In some aspects, the wash system 52 includes a dry ice injection unit to hold dry ice in the form of solid pellets. The solid pellets of dry ice are driven by compressed air through the one or more access ports 212.

In some embodiments, the device 218 is also equipped with an acoustic source 219. The acoustic source 219 can be used to subject the component 202 to an acoustic treatment to dislodge the contaminant deposit 204 or portions thereof. The acoustic treatment is performed after one or more transient thermal cycles and can either be performed either before or after a cleaning operation that follows the one or more transient thermal cycles. It is contemplated that after exposure to a transient thermal cycle, any in-situ cracks in the contaminant deposit 204 can be provided energy to cause spallation (e.g., complete spallation) with the help of acoustic waves delivered from the acoustic source 219.

Referring to FIG. 3, one example of a device 300 that can be used to clean a component 302 of a gas turbine engine with a transient thermal cycle is provided. The device 300 uses a laser as the thermal energy source. In the exemplary embodiment of FIG. 3, the component 302 includes a fan blade circumferentially surrounded by an engine casing 304. Though, it is contemplated that the component 302 can be any component of a gas turbine engine (e.g., engine 10 of FIG. 1), for example, any component of the engine core (e.g., the engine core 51 of FIG. 1).

As will be appreciated, the device 300 is a laser assembly 306 and includes a probe 308, a laser source 310, a lens 312 and a mirror 314. The probe 308 is coupled to the laser source 310 at a proximal end portion 320 and a distal end portion 322 is configured to be inserted into the engine core (i.e., through the engine casing 304) through the port 316. The lens 312 and the mirror 314 are coupled to the probe 308 near the distal end portion 322.

As described above, to remove a contaminant deposit, the laser assembly 306 subjects the component 302 to one or more transient thermal cycles. As will be appreciated, the transient thermal cycle stresses the contaminant deposit, thereby weakening the contaminant deposit for removal. In this manner, the laser assembly 306 directs a laser beam 318 on the contaminant deposit (204 as shown in FIG. 2) formed on the surface of the component 302. In some embodiments, the laser beam 318 has a power in the range of 100 W to 10 kW and operates at a pulse repetition frequency in the range of 1 pulse per second to 50 pulse per second. The spot size on the surface of the component 302 may be from 0.05 mm diameter to 10 mm diameter. As a result, a surface temperature of the component 302 changes by at least 373 K and up to 1,773 K within a transient thermal cycle. In some embodiments, the surface temperature of the component 302 changes at a rate of at least 100,000 K per second within the transient thermal cycle. The transient thermal cycle may also induce a temperature gradient in the range of about 1,000 K/mm to 50,000 K/mm within the contaminant adjacent to the component 302. Moreover, the transient thermal cycle may induce internal stresses in the contaminant deposit adjacent to the component in the range of about 30 MPa to about 500 MPa around the circumference of the spot size of the laser beam 318 and a shear stress at an interface between the contaminant deposit and the component in the range of about 1 MPa to about 100 MPa.

As will be appreciated, the laser power, spot size, pulse duration and pulse repetition frequency may be optimized to increase (e.g., maximize) the damage to the deposit, depending on parameters including the degree of cohesion of the deposit, the thickness of the deposit and the thermal properties (coefficient of thermal expansion, specific heat capacity, conductivity, etc.) of the deposit and the component 302. It is generally contemplated that the parameters of the laser assembly 306 are selected to facilitate the weakening, removal and spallation of the contaminant deposit without ablating a surface the component 202. Further, it is generally contemplated that other suitable pulse repetition frequencies of the laser beam 318 may be used. As will be appreciated, in one aspect, the exposure time (i.e., the pulse repetition frequency) may be selected based on a time for the induced heat to dissipate between pulses to avoid thermally damaging the component. In another aspect, however, the laser beam is focused on different target regions of the contaminant deposit between pulses such that the pulse repetition frequency is independent of the thermal properties of the contaminant deposit or the component. For example, the gas turbine engine may be rotated during the laser beam 318 exposure or a galvanometer actuator 342 may adjust an incident angle of the laser between 318 between pulses such that any pulse repetition frequencies (i.e., 1-50 pulses per second or above) may be used.

The lens 312 may be a diverging lens or a converging lens. It is contemplated that as the laser beam 318 passes through the diverging lens, the laser beam 318 spreads out or expands to induce a large spot size on the component 302 to generate a significant thermal gradient and differential strain over a large region of contaminants on the component 302. Further, it is contemplated that as the laser beam 318 passes through the converging lens, the laser beam 318 is focused or converges to induce a small spot size on the component 302 to precisely target a specific region on the component 302.

As depicted in FIG. 3, the laser assembly 306 includes a mirror 314 to control the laser beam 318 path from the laser source 310 to the component 302. In some embodiments, the mirror 314 is coupled to a galvanometer actuator 342 for adjusting an incident angle of the laser beam 318. In some aspects, the galvanometer actuator 342 is configured to adjust an incident angle of the laser beam 318 between pulses of the laser beam 318.

Further, in some embodiments, the laser assembly 306 includes one or more sensors 324 to measure a characteristic of a condition of the component 302. The sensor(s) can include, for example, a back-scattered optical detector, an optical sensor, an acoustic sensor, an ultrasonic sensor, an IR camera, and/or any other suitable sensing device. For example, the one or more sensors 324 collect optical data from the laser beam 318 to characterize a surface condition of the component 302 and/or differentiate between the component 302 and the deposited contaminant based on the spectral analysis of the optical data. The optical data acquired by the one or more sensors 324 can include data on the light that is backscattered or reflected back towards the laser source 310. Laser backscatter data can be used to characterize a surface of the component 302 and discriminate between the component 302 and a contaminant deposit by looking at dispersion characteristics of the backscatter data. For example, when dust from sand is present, the backscatter data may include widely distributed specular reflection whereas a metallic substrate (e.g., the component 302) may include more closely spaced reflection. In some examples, the backscatter data is imaged through a beamsplitter or reflector. In one example, the optical data includes backscatter data from the laser beam 318. The received optical data may be communicated with a controller 326. The controller 326 may be operatively connected to the one or more sensors 324 to receive the optical data via a wired or wireless network. such as a network 338.

In some embodiments, the one or more sensors 324 of the laser assembly 306 includes an optical sensor. The optical sensor can be configured to image a target surface using the lens 312 and the mirror 314 of the laser assembly 306.

The controller 326 typically comprises one or more processors 328 and/or microprocessors. The controller 326 also comprises a memory 330 that stores the operational code or set of instructions 334 that is executed by the controller 326 and/or the one or more processors 328 to implement the functionality of the laser assembly 306, or portions thereof. In some embodiments, the memory 330 may also store some or all of the data 332 associated with operation of the laser assembly 306, and the component 302. It is further understood that the controller 326 may include common accompanying accessory devices, including memory, transceivers for communication 336 with other components and devices, etc.

In some embodiments, the controller 326 is configured to control operation of the laser beam 318. For example, the controller 326 is configured to adjust or control a power, a pulse repetition frequency, and/or a spot size of the laser beam 318 based on the optical data. In some forms, the controller 326 is configured to determine the absorption characteristics of the dust (i.e., contaminant deposit) based on a comparison of the backscatter optical data to a predetermined threshold (i.e., a dust free component) or a baseline heating rate and adjust the laser power density based on the absorption characteristics. Additionally or alternatively, the controller 326 is configured to determine a number of additional transient cycles (i.e., exposure to the laser beam 318) based on the optical data. In some embodiments, the controller 326 is configured to adjust or rotate the mirror 314, by activating the galvanometer actuator 342, based on the optical data to control the incident angle of laser beam 318 on the component 302. Rotation of the mirror 314 can allow the device 300 to direct the laser beam 318 to reach confined spaces or difficult to access structures.

In some embodiments, the laser assembly 306 may further include an imaging device as the sensor 324 operatively connected to the controller 326 for identifying the presence of contaminants of the component 302. The imaging device may include, for example, a charge-coupled device (CCD) camera, an infrared (IR) camera, or any other suitable imaging device. The imaging device optically images the component 302 or an identified target region thereof. The controller 326 may control one or more parameters of the laser assembly 306 based on the optical image data. For example, the controller 326 may control a spot size 340 (e.g., a small laser spot size or a large laser spot size) of the laser beam 318 based on presence and/or distribution of contaminants on the component 302. In some aspects, a small laser spot size is used to precisely target a specific contaminant region. In other aspects, a large laser spot size is used to generate a significant thermal gradient and induce a differential strain over a large region of contaminants on the component 302. In another example, the controller 326 controls a power, frequency and/or target location of the laser beam 318 based on the optical image data.

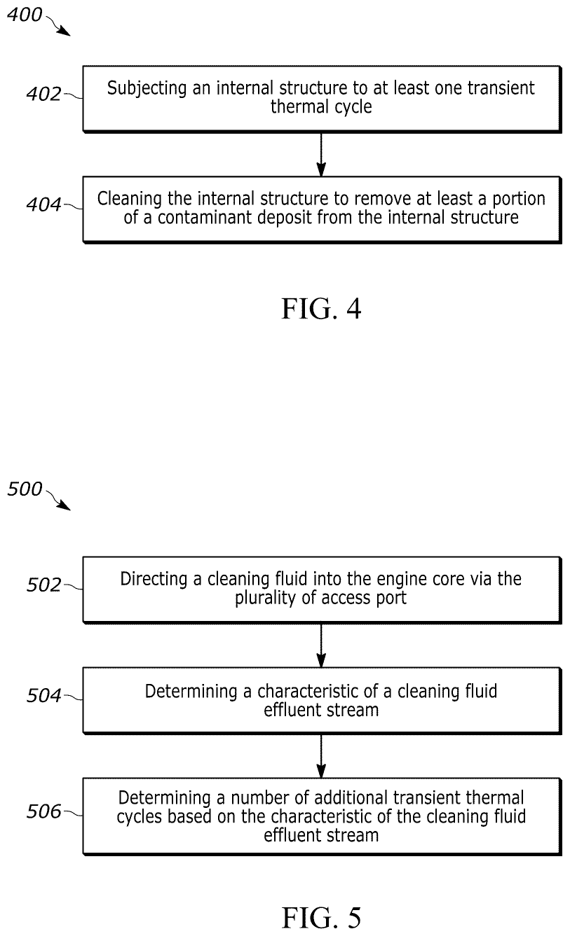

In some embodiments, the device 300 may further include an acoustic source, such as the acoustic source 219 shown in FIG. 2. After the one or more transient thermal cycles, the contaminant and the component 302 may be provided with acoustic waves from the acoustic source (e.g., acoustic source 219 in FIG. 2) to provide energy to in-situ developed cracks or structural defects in the contaminant deposit to facilitate the complete spallation of the contaminant deposit. Referring to FIG. 4, a flow diagram is provided illustrating an exemplary method 400 for cleaning a component within gas turbine engine. In some embodiments, the gas turbine engine is the engine 10 as shown in FIG. 1. The component to be cleaned can be any component of a gas turbine engine 200 (e.g., the engine 10 of FIG. 1). As will be appreciated, the engine 10 includes a plurality of access ports 50 within the engine core 51 compressor section (e.g., the LP compressor 20 and HP compressor 22), the combustor section 24, and the turbine section (e.g., the HP turbine 26, LP turbine 28) and, in some embodiments, the component is disposed within the engine core 51 as shown in FIG. 1.

The method 400, at block 402, includes subjecting the component to at least one transient thermal cycle. The wash system 52 that is shown and described with reference to FIG. 1 can be used to subject the component to the at least one transient thermal cycle. For example, the second storage tank 70 can be used to deliver a medium through the distribution manifold 56 and the delivery conduit(s) 58 to a component of the engine 10 via one or more of the access ports 50. The device 300, e.g., the laser assembly 306, that is shown and described with reference to FIG. 3 can also be used to subject the component to at least one transient thermal cycle. The component may be a component of the engine 10 of FIG. 1.

In some embodiments, such as where a fluid medium or non-laser thermal energy source is used to accomplish the at least one transient thermal cycle, a surface temperature of the component changes by at least about 100 K per second within a transient thermal cycle. In some embodiments, such as where a laser is used to accomplish the at least one transient thermal cycle the surface temperature of the component changes at a rate of at least 100,000 K per second within a transient thermal cycle. The at least one transient thermal cycle may include a cold cycle or a hot cycle. The cold cycles includes exposing the component to a cooling medium such as cold air, inert gas, water, ice, dry ice, liquid nitrogen, or a refrigerant coolant in the temperature range of about 77 K to 300 K, and the hot cycle includes exposing the component to a thermal energy source such as hot air, hot water, steam, or a laser in the temperature range of 323 K to 1,000 K.

In some approaches, the at least one transient thermal cycle includes two or more thermal cycles. The two or more thermal cycles may include two hot cycles, two cold cycles, a hot cycle followed by a cold cycle, a cold cycle followed by a hot cycle, or any combination thereof. For example, the two or more thermal cycles include exposing the component to a cooling medium such as dry ice, liquid nitrogen, or a refrigerant coolant and then exposing the component to a thermal energy source such as steam, or vice versa. The rapid change in temperature between the cold source and the hot source, or vice versa, causes a differential expansion or contraction between the contaminant deposit and the component, leading to internal stresses that weaken the bond between the contaminant deposit and the component. The cooling medium and the thermal energy source are chosen such that there is a significant temperature differential between an initial temperature of the engine core to maximize the resulting internal stresses.

The two or more transient thermal cycles may be accomplished using the same device or using two or more different devices, for example, one device for hot cycles and one device for cold cycles. In some approaches, when multiple devices are used to subject the component to the transient thermal cycles, the devices can be inserted at the same time, e.g., coupled to a single arm or insertion tool. In other approaches, the devices used to subject the component to the transient thermal cycles can be inserted one after the other, with each device coupled to a separate insertion tool or arm.

In some approaches, before subjecting the component of the engine to at least one transient thermal cycle, the engine core is at an initial temperature in the range of about 333 K or lower.

Additionally or alternatively, in some embodiments, before subjecting the component of the engine to at least one transient thermal cycle, the engine core is at an initial temperature of about 573 K or greater (e.g., for a turbine engine that has just shut down). For an engine at such temperatures after shut down, the component may be exposed to a cooling cycle. In this manner, the cooling cycle may induce a rapid temperature change of the component. For example, the cooling cycle may involve exposing the hot engine to room temperature water (e.g., distilled water or deionized water). Such an approach may be effective at removing contaminant deposits and economical, as it utilizes residual heat from engine operation as a hot cycle.

In other embodiments, before subjecting the component of the engine to at least one transient thermal cycle, the engine core may be at an initial temperature of about 313 K or great or about 333 K or greater (e.g., for a turbine engine that has been subjected to dry motoring after shut down and before a cleaning operation). For an engine that has been subjected to dry motoring after shut down and before a cleaning operation, the component may be exposed to a hot cycle to raise the temperature, for example, to 363 K or higher and then exposing the engine to a cold cycle. In some examples, in such an approach the thermal energy source to reheat the engine in the hot cycle is hot water and the cooling medium in the cold cycle can be cold water (e.g., at about 283 K).

In some approaches, the method 400 further comprises rotating one or more components of the compressor section or the turbine section of the gas turbine engine while subjecting the engine core to the at least one transient thermal cycle. In some approaches, a motor or hand crank may be used to rotate the one or more components of the compressor section or the turbine section of the gas turbine engine. In addition, or as an alternative, a controller may automatically control the rotation of the gas turbine engine using, e.g., the motor.

The method 400 further includes, at block 404, cleaning the component to remove at least a portion of a contaminant deposit from the component. The cleaning may include a wet process or a mechanical process. In particular, the wet process includes directing a cleaning fluid into the engine core via the plurality of access ports to remove at least a portion of the contaminant deposit and the mechanical process includes a brush and/or a vacuum into the engine core via the plurality of access ports to remove away the contaminant deposit. The wash system 52 that is shown and described with reference to FIG. 1 can be used to clean the component to remove the contaminant deposit. For example, the distribution manifold 56 and the delivery conduit(s) 58 can be used to distribute cleaning fluid through tone or more access ports 50 of the engine 10 to remove contaminant deposits from a component of the engine 10. As used herein, “cleaning fluid” refers to any suitable fluid in a liquid or gas phase to remove the contaminants. The cleaning fluid may include, but is not limited to, air, inert gas, cleaning solution such as soap detergent or foam detergent, water, an acid, an organic solvent or any combination thereof. It should be appreciated that while the term “wash” is often used to describe a wet process involving a liquid or foam washing medium, in the context of the present embodiments, it is intended to encompass all cleaning processes which involve rotation of the gas turbine engine during the cleaning process including, without limitation, water wash, foam wash, abrasive media cleaning, dry ice (carbon dioxide) blasting, frozen liquid media cleaning exhibiting a phase change during the wash, laser ablative cleaning and the like.

In some embodiments, a single system or delivery device/equipment is used to subject the component to the transient thermal cycle(s) and to clean the component. Such a device may be, for example, a portable wash cart such as the that is equipped with a tank with a medium for the transient thermal cycle and a tank with cleaning solution for cleaning (see e.g., the wash system 52 of FIG. 1). As such, the delivery conduits and/or manifolds (e.g., distribution manifold 56 and the delivery conduit(s) 58 of FIG. 1) can remain coupled to the engine during the method 400 and such equipment can be cycled between the transient thermal cycles and/or the cleaning operations. It is contemplated that physical connections to different sources, for example, to certain tanks and/or piping, may need to be adjusted or changed depending on whether the transient thermal cycles and/or cleaning operation is being performed. For example, the distribution manifold 56 and/or the delivery conduit(s) 58 may need to be disconnected and/or connected to the storage tank 62 and/or the second storage tank 70 depending on whether a transient thermal cycle or cleaning operation is being performed.

In some embodiments, separate systems or delivery devices/equipment are used to subject the component to the transient thermal cycle(s) and to clean the component. For example, a transient thermal cycle may be performed using the device 300 of FIG. 3 (e.g., the laser assembly 306). The device 300 may be inserted into the access port 50 for performing the transient thermal cycle and then removed before the cleaning operation. For the cleaning operation, the cleaning system 52 can then be used. For example, the distribution manifold 56 and/or the delivery conduit(s) 58 may be coupled to the access port 50 so that a cleaning fluid can be delivered to the component from the storage tank 62.

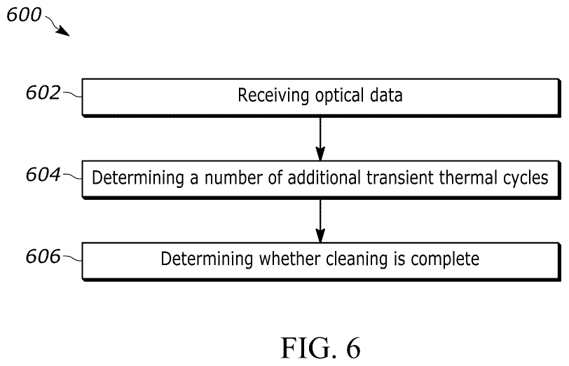

Referring to FIG. 5, a flowchart of an exemplary method 500 for cleaning the component after subjecting the component to at least one transient thermal cycle is provided. In some approaches, the component is a component of the engine 10 of FIG. 1. The component may also be the component 202 of FIG. 2 or the component 302 of FIG. 3. The method 500 or portions thereof can be performed using the wash system 52.

At block 502, a cleaning fluid is directed into the engine core via the plurality or access ports. The cleaning fluid may include a foam detergent. As the cleaning fluid is directed into the engine core as described above, the cleaning fluid removes, dissolves, or otherwise carries away at least a portion of the contaminants on the component subjected to one or more transient thermal cycles as described with reference to FIG. 4. The cleaning fluid exits the engine core as a cleaning fluid effluent stream. The cleaning fluid effluent stream includes at least a portion of the cleaning fluid that exits the engine core following the cleaning step. In some approaches, the wash system 52 of FIG. 1 or portions thereof can be used to direct cleaning fluid into the engine core.

At block 504, at least one characteristic of the cleaning fluid effluent stream is determined. The characteristic includes at least one of a color, a density, a pH value, a turbidity, a level of total dissolved solids (TDS), a salinity, an electrical characteristic such as a conductivity or a resistivity, or a concentration value for the cleaning fluid effluent stream. In some aspects, one or more sensors may measure the characteristics of the cleaning fluid effluent stream.

At block 506, a number of additional transient thermal cycles is determined. The number of additional transient thermal cycles for the component of the gas turbine engine is based, at least in part, on the measured characteristics. In some aspects, a controller is configured to receive data indicative of the characteristics of the cleaning fluid effluent stream at various stages of cleaning cycle (e.g., every 5 minutes, 15 minutes, 30 minutes, hour, etc.) from the one or more sensors and determine the number of additional transient thermal cycles based on the received data. The controller may be, for example, the controller 326 shown and described with reference to FIG. 3 or a controller associated with the wash system 52 of FIG. 1. For example, the controller may compare the measured characteristic of the cleaning fluid effluent stream to a threshold to determine the number of additional transient thermal cycles. The threshold may include a range of values associated with a different required number of transient thermal cycles.

In one non-limiting example, the cleaning fluid effluent stream is sampled at various stages of the cleaning cycle (e.g., every 30 minutes) to visually inspect a change in the color of the cleaning fluid effluent stream. Based on the color of or the change of color of the cleaning fluid, such as light or dark, the number of additional transient thermal cycles or cleaning cycles is determined. If the color is light, indicating no or little dirt is present, the cleaning operation will be stopped. If the color is dark, indicating that dirt is still present, the cleaning operation will be continued for another 30 minute cycle. In this manner, 30 minute cleaning cycles can be performed until the sample appears light.

However, if the measured characteristics indicate that all or substantially all of the contaminant deposit has been removed at block 506, the method 500 may be terminated. For example, the controller may compare the measured characteristic of the cleaning fluid effluent stream to a threshold. The controller may be, for example, the controller 326 shown and described with reference to FIG. 3 or a controller associated with the wash system 52 of FIG. 1. If the measured characteristic is less than the threshold, the method 500 may be terminated such that the component is not subjected to any additional cleaning cycles or transient thermal cycles.

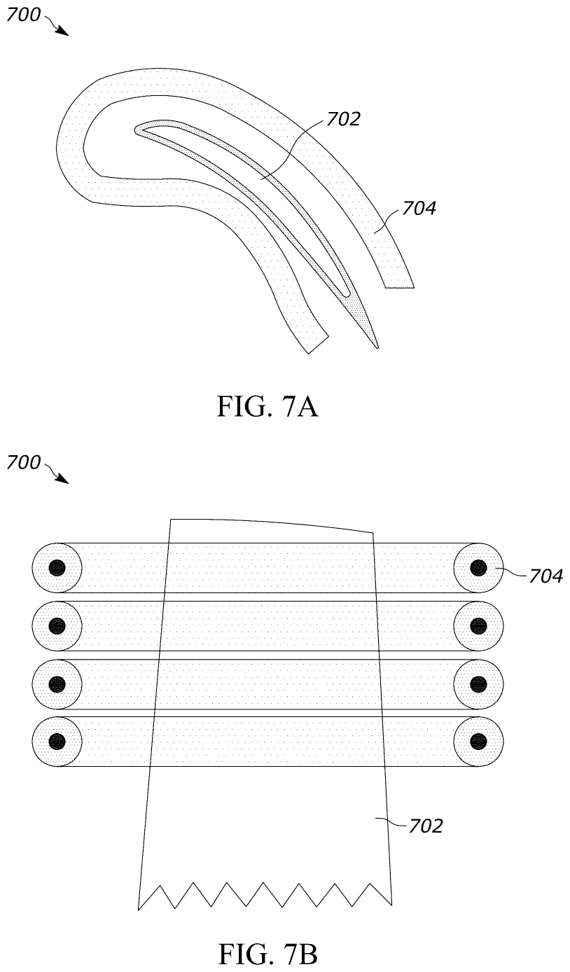

Referring to FIG. 6, a flowchart of an exemplary method 600 for subjecting the component to at least one transient thermal cycle is provided. The at least one transient thermal cycle includes a hot cycle. In particular, the hot cycle includes exposing the component to a laser as shown in FIG. 3. In some approaches, the method 600 may be performed by a controller such as the controller 326 shown in FIG. 3 and implemented as instruction in the memory and executed by the processor 328.

At block 602, optical data from the laser representative of a condition of the component of the gas turbine engine is received. The optical data may be collected by one or more sensors and may be representative of backscattered light scattered or reflected from the contaminant deposits and or the component. The backscattered light may be indicative of a material composition, structural information, and thickness of the contaminant deposit on the component. The controller may be configured to receive the optical data from the one or more sensors.

In some approaches, the controller may receive the optical data from the one or more sensors and determine that the laser is focused on the contaminant deposit formed on the component. Additionally, the controller may adjust a parameter of the laser (i.e., power, frequency, angle) based on the received optical data.

At block 604, a number of additional transient thermal cycles is determined. The number of additional transient thermal cycles for the component of the gas turbine engine is based, at least in part, on the optical data. In some aspects, the controller is configured to analyze the optical data to identify the presence of contaminants deposited on the internal surface and determine the number of additional transient thermal cycles based on the identified presence of contaminants.

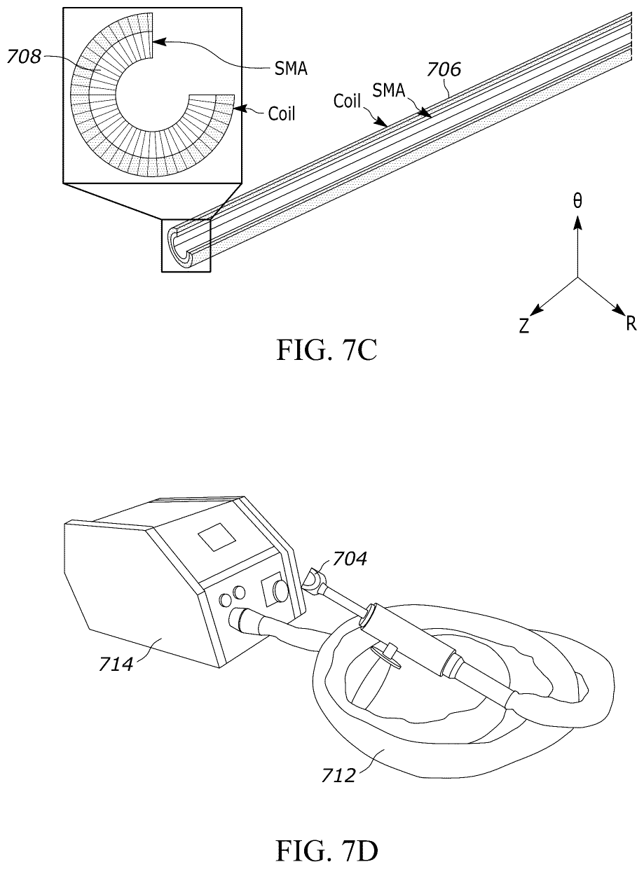

Referring to FIGS. 7A and 7B, another example of a device 700 that can be used to clean a component 702 and/or to subject the component 702 to a transient thermal cycle as described herein of a gas turbine engine is provided. For example, the device 700 can be used to subject the component 702 to one or more hot cycles as described herein. FIG. 7A shows a top view and FIG. 7B shows a side view of the device 700. In some forms, the device 700 may be incorporated in the device 218 as shown and described with reference to FIG. 2. In the exemplary embodiment of FIG. 7A-7B, the component 702 includes a turbine blade. Though, it is contemplated the component 702 can be any component of a gas turbine engine (e.g., engine 10 of FIG. 1) and, in some aspects, can be any component of an engine core (e.g., the engine core 51 in FIG. 1). As will be appreciated, the device 700 includes an induction coil 704, such as a moveable induction coil. The transient thermal cycle is achieved using the induction coil 704 that is inserted through an access port such as access port 50 as shown in FIG. 1. In one example, the induction coil 704 can be mounted on a translation mechanism that is sized to fit through the access port and movement of the translation mechanism is achieved using an electrical motor. In another example, the induction coil 704 is disposed in a rigidized guide tube. The rigidized guide tube can be controlled externally and used to deploy the induction coil 704.

The induction coil 704 at least partially surrounds the component 702. In some forms, the induction coil 704 has a coil diameter of less than 10 mm, such as, for example, about 5 mm to about 10 mm with a thickness in the range of about 2 mm to about 4 mm and a thickness less than about 4 mm in a curved portion of the induction coil 704.

In some forms, the induction coil 704 includes a C-shaped induction coil. The C-shaped induction coil is sized and shaped to be translated along a length of the component 702, such as from a tip to a root section of the turbine blade (e.g., to encompass a leading edge or trailing edge of the blade). For example, the thickness of the induction coil 704 may be less than about 4 mm or, in some aspects, may be between about 2 mm and 3 mm in a curved portion of the induction coil 704 to encompass the leading or trailing edge of the turbine blade. In some examples, the curved length of the induction coil 704 may be between about 2 mm and about 3 mm. In this manner, the C-shaped induction coil is inserted through the access port and arranged proximal a top of the component 702, such as a top of the turbine blade. During the transient thermal cycles, the C-shaped induction coil is moved from the tip of the turbine blade down to the root of the turbine blade.

Additionally, alternatively, the induction coil 704 includes an array of C-shaped coils, such as, for example, two or more C-shaped coils on a flexible substrate. The flexible substrate is coupled to a deployment mechanism. The deployment mechanism may include a translation mechanism actuated by an electrical motor or a rigidized guide tube such as a miniaturized robotic snake arm or any other suitable deployment mechanism. The deployment mechanism is configured to move the flexible substrate along the component 702, such as from a tip to a root of a turbine blade or vice versa. In some forms, after the flexible substrate is disposed transverse the edge of the component via the deployment mechanism. The component can be indexed and the deployment mechanism may then move the flexible substrate to another turbine blade.

It is contemplated that the induction coil 704 is suitably designed to heat the dust layer (i.e., the contaminant deposit) or the coating as opposed to the metallic blade. Further, although this particular example uses a turbine blade as the component 702, it should be understood that the C-shaped coils and the deployment mechanism may be used to clean any various components within the engine core such as, for example, the shrouds, blades, and vanes in the gas turbine.

The induction coil 704 generates an electromagnetic field that induces a current, such an electromagnetic current, within the component 702 to provide heating and differential thermal expansion between a contaminant deposit formed on the component 702. In some forms, the induction coil 704 is operated at a frequency in the range of about 1 KHz to about 10 MHz. The induction coil 704 may provide rapid or instantaneous heating to the contaminant deposit formed on the internal structure. As the induction coil 704 moves and locally heats different regions of the contaminant deposit formed on the component 702, the differential thermal expansion causes internal stresses within the contaminant deposit, removing or weakening the adhesion of the contaminant deposit formed on the component 702. In some embodiments, the induction coil 704 comprises a coil 706 and a shape memory alloy (SMA) 708 as shown in FIG. 7C. In the exemplary embodiment of FIG. 7C, the coil 706 surrounds the SMA 708. In some forms, the magnetic field generated by the coil 706 induces currents within the SMA 708. As the SMA 708 is heated due to the induced currents, the SMA 708 may change shape, adjusting a shape of the coil 706 to align with a surface profile of the component 702.

In some embodiments, the device 700 includes an induction cable 712 with a proximal end coupled to the induction coil 704 and a distal end coupled to a controller 714 as shown in FIG. 7D. The controller 714 may include one or more processor and/or microprocessors, a user interface and a display. In some forms, the user interface may include a touch screen or one or more buttons for adjusting one or more parameters of the induction coil before, during, or after the one or more transient thermal cycles. In some forms, the display will provide a visual display of the parameters of the induction coil.

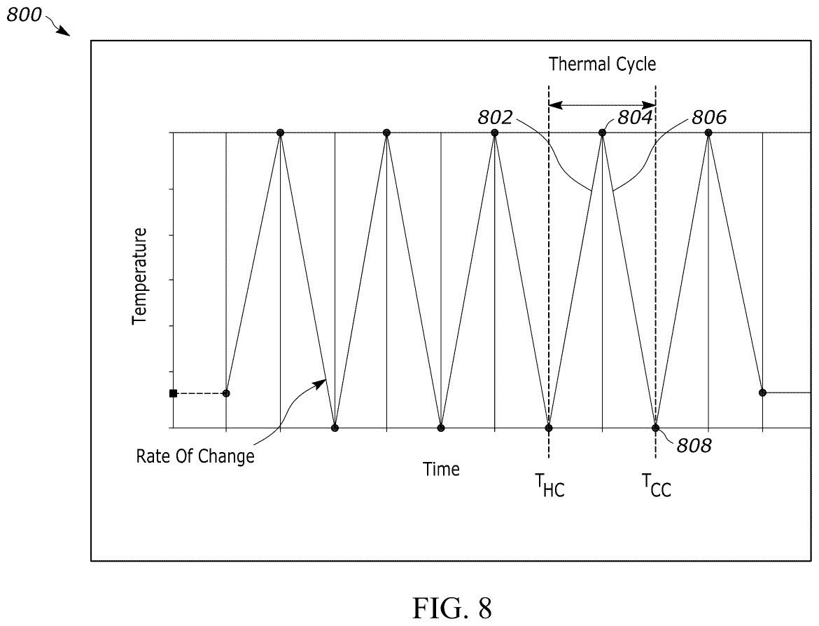

FIG. 8 includes a graph 800 that represents the rate of change of temperature of a component with a contaminant deposit formed thereon during multiple transient thermal cycles. The x-axis shows the time (e.g., seconds) the component is subjected to the multiple transient thermal cycles and the y-axis shows the temperature of the component.

As can be seen, FIG. 8 shows multiple transient thermal cycles including alternating hot and cold cycles, and particularly a hot cycle followed by a cold cycle, with no intervals of constant temperature. Although this particular example uses alternating hot and cold cycles, it should be understood that any various combination of transient thermal cycles may be used. The section lines (vertical dashed lines in FIG. 8) represent the duration of two transient thermal cycles with the initial time (T_{HC}) when the component is exposed to a hot cycle and an end time (T_{CC}) after the component is exposed to the cold cycle following the hot cycle. Line 802 shows the rate at which the surface temperature of the component increases during the hot cycle. As can be seen, during the heating cycle the surface temperature of the component rises from an initial temperature to a maximum surface temperature 804. Following the hot cycle, the cooling cycle commences where the surface temperature of the component decreases from the maximum surface temperature 804 to a minimum surface temperature 808. Line 806 shows the rate at which the surface temperature of the component decreases during the cold cycle. As can be seen, throughout the two transient thermal cycles, the temperature is in a state of flux, either increasing or decreasing, with no periods of temperature stabilization.

It is contemplated that the rate at which the surface temperature of the component increases depends on the thermal energy source used. However, it should be understood that, in some embodiments, the surface temperature of the component increases by a rate of at least 100 K per second within the hot cycle. Such rates of temperature increase may be achieved, for example, when a fluid thermal energy source is employed and/or when a non-laser thermal energy source is employed in the hot cycle. Further, it is contemplated that the rate at which the surface temperature of the component decreases depends on the cooling medium used. In some embodiments, the surface temperature of the component decreases by a rate of at least 100 K per second within the cold cycle. Such rates of temperature decrease may be achieved, for example, when a fluid cooling medium is employed in the cold cycle.

Further, in some forms, it is contemplated that the surface temperature of the component may linearly increase during the hot cycle and linearly decrease during the cold cycle as can be seen in FIG. 8 or may non-linearly increase and/or decrease during the hot cycle and the cold cycle, respectively. In addition, or as an alternative, the rate at which the surface temperature of the component increases or decreases may be adjusted to different rates based on the parameters of the hot cycle and the cold cycle.

Further aspects of the disclosure are provided by the subject matter of the following clauses:
A method for cleaning a component of a gas turbine engine, the component disposed within an engine core, the gas turbine engine defining a plurality of access ports within the engine core, the method comprising: subjecting the component to two or more transient thermal cycles, wherein a surface temperature of the component changes by at least 293 degrees kelvin within a transient thermal cycle; and cleaning the component to remove at least a portion of a contaminant deposit from the component.

The method of any preceding clause, wherein a surface temperature of the component changes by a rate of at least about 100 K per second within at least one of the two or more transient thermal cycles.

The method of any preceding clause, wherein at least one of the two or more transient thermal cycles comprises a cold cycle.

The method of any preceding clause, wherein the cold cycle comprises exposing the component to a cooling medium, wherein the cooling medium is at a temperature in the range of about 77 K to about 300 K.

The method of any preceding clause, wherein the cooling medium comprises at least one of cold air, water, ice, dry ice, liquid nitrogen, or a refrigerant coolant.

The method of any preceding clause, wherein at least one of the two or more transient thermal cycles comprises a hot cycle.

The method of any preceding clause, wherein the hot cycle comprises exposing the component to a thermal energy source, and wherein the thermal energy source is at a temperature in the range of about 323 K to about 1,000 K.

The method of any preceding clause, wherein the thermal energy source comprises at least one of hot air, hot water, steam, or a laser.

The method of any preceding clause, wherein the thermal energy source comprises a laser, wherein the laser comprises a laser assembly including a probe for directing a laser beam to a target, the probe extends from a proximal end portion that is coupled to a laser source to a distal end portion that focuses the laser on the target, the distal end portion of the probe including a lens for adjusting the laser beam and a mirror for directing the laser beam towards the target.

The method of any preceding clause, wherein cleaning the component comprises directing a cleaning fluid into the engine core via the plurality of access ports, and wherein the method further comprises: determining a characteristic of a cleaning fluid effluent stream, the cleaning fluid effluent stream comprising at least a portion of the cleaning fluid that exits the engine core following the cleaning step; and determining a number of additional transient thermal cycles for the component of the gas turbine engine based, at least in part, on the characteristic of the cleaning fluid effluent stream.

The method of any preceding clause, wherein cleaning the component to remove at least the portion of the contaminant deposit from the component comprises exposing the contaminant deposit and the component to acoustic waves from an acoustic source after the two or more transient thermal cycles.

A method for cleaning a component of a gas turbine engine, the component disposed within an engine core, the gas turbine engine defining a plurality of access ports within the engine core, the method comprising: subjecting the component to a transient thermal cycle, the transient thermal cycle comprises exposing the component to a laser beam, wherein a surface temperature of the component changes by at least 373 degrees kelvin within the transient thermal cycle; and cleaning the component to remove at least a portion of a contaminant deposit from the component.

The method of any preceding clause, wherein a temperature gradient in the range of about 1,000K per millimeter to about 50,000K per millimeter within the contaminant deposit adjacent to the component is formed within the transient thermal cycle.

The method of any preceding clause, wherein the surface temperature of the component changes by a rate of at least 100,000 K per second within the transient thermal cycle.

The method of any preceding clause, wherein a temperature rise of the component within the transient thermal cycle is less than 473 K.

The method of any preceding clause, wherein the laser beam has a power in the range of 100 W to 10 kW.

The method of any preceding clause, wherein the laser beam induces internal stresses in the contaminant deposit adjacent to the component in the range of about 30 MPa to about 500 MPa around a circumference of a spot size of the laser beam.

The method of any preceding clause, wherein the laser beam induces a shear stress at an interface between the contaminant deposit and the component in the range of about 1 MPa to about 100 MPa.

The method of any preceding clause, wherein the laser beam has a pulse repetition frequency in the range of about 1 pulse per second to 50 pulses per second, and wherein the method further comprises adjusting an angle of the laser beam such that a portion of the contaminant deposit adjacent to the component exposed to the laser beam changes between pulses.

The method of any preceding clause, further comprising inserting a probe through one of the plurality of access ports to expose the component to the laser beam, wherein the probe extends from a proximal end portion that is couped to a laser source to a distal end portion that focuses the laser beam on the component, the distal end portion of the probe include a lens for adjusting the laser beam and a mirror for directing the laser beam towards the component and a galvanometer operatively coupled to the mirror for adjusting an angle of the laser beam, and wherein the method further comprises adjusting the angle of the laser beam between thermal cycles or between pulses of the laser beam.

A method for cleaning a component of a gas turbine engine, the component disposed within an engine core, the gas turbine engine defining one or more access ports within the engine core, the method comprising: subjecting the component to two or more transient thermal cycle, wherein a surface temperature of the component changes by at least 293 degrees kelvin within a transient thermal cycle; and cleaning the component to remove at least a portion of a contaminant deposit from the component.

The method of any preceding clause, wherein a surface temperature of the component changes by a rate of at least 100 K per second within at least one of the two or more transient thermal cycles.

The method of any preceding clause, wherein a surface temperature of the component changes at a rate of at least 100,000 K per second within at least one of the two or more transient thermal cycles.

The method of any preceding clause, wherein at least one of the two or more transient thermal cycle comprises a cold cycle.

The method of any preceding clause, wherein the cold cycle comprises exposing the component to a cooling medium.

The method of any preceding clause, wherein the cooling medium is at a temperature in the range of about 77 K to about 300 K.

The method of any preceding clause, wherein the cooling medium comprises at least one of cold air, water, ice, dry ice, liquid nitrogen, or a refrigerant coolant.

The method of any preceding clause, wherein at least one of the two or more transient thermal cycles comprises a hot cycle.

The method of any preceding clause, wherein the hot cycle comprises exposing the component to a thermal energy source.

The method of any preceding clause, wherein the thermal energy source is at a temperature in the range of about 323 K to about 1,000 K.

The method of any preceding clause, wherein the thermal energy source comprises at least one of hot air, hot water, steam, or a laser.

The method of any preceding clause, wherein the laser comprises a laser assembly including a probe for directing a laser beam to a target, the probe that extends from a proximal end portion that is coupled to a laser source to a distal end portion that focuses the laser on the target, the distal end portion of the probe including a lens for adjusting the laser beam and a mirror for directing the laser beam towards the target.

The method of any preceding clause, wherein the laser further comprises a galvanometer operatively coupled to the mirror for adjusting an angle of the laser beam.

The method of any preceding clause, wherein the laser has a power in the range of 100 W to 10 kW.

The method of any preceding clause, wherein the laser operates at a pulse repetition frequency in the range of 1 pulse per second to 50 pulses per second.

The method of any preceding clause, further comprising: receiving optical data from a sensor associated with laser.

The method of any preceding clause, wherein the optical data comprises backscatter data, the backscatter data indicative of a condition of the component of the gas turbine engine.

The method of any preceding clause, further comprising: determining a number of additional transient thermal cycles for the component of the gas turbine engine based, at least in part, on the optical data.

The method of any preceding clause, further comprising: determining whether cleaning of the component is complete based, at least in part, on the optical data.

The method of any preceding clause, wherein the one or more access ports are borescope ports.

The method of any preceding clause, wherein before subjecting the engine core to the transient thermal cycle, the engine core is at an initial temperature in the range of about 313 K to about 333 K.

The method of any preceding clause, wherein the engine core comprises a compressor section, a combustor section, and a turbine section, and wherein the method further comprises rotating one or more components of the compressor section or the turbine section of the gas turbine engine while subjecting the engine core to the transient thermal cycle.

The method of any preceding clause, wherein cleaning the component comprises directing a cleaning fluid into the engine core via the one or more ports.

The method of any preceding clause, wherein the method further comprises: determining a characteristic of a cleaning fluid effluent stream, the cleaning fluid effluent stream comprising at least a portion of the cleaning fluid that exits the engine core following the cleaning step.

The method of any preceding clause, wherein characteristic of the cleaning fluid effluent stream corresponds to a level of the contaminant deposit present in the cleaning fluid effluent stream.

The method of any preceding clause, wherein the characteristic comprises at least one of a density, a pH value, a turbidity, a level of total dissolved solids (TDS), a salinity, an electrical characteristic, or a concentration value for the cleaning fluid effluent stream.

The method of any preceding clause, wherein the electrical characteristic comprises at least one of a conductivity or a resistivity of the cleaning fluid effluent stream.

The method of any preceding clause, further comprising: determining a number of additional transient thermal cycles for the component of the gas turbine engine based, at least in part, on the characteristic of the cleaning fluid effluent stream.

The method of any preceding clause, further comprising: comparing the characteristic of the cleaning fluid effluent stream to a threshold, wherein the number of additional transient thermal cycles is based, at least in part, on the comparing step.

The method of any preceding clause, wherein the threshold comprises a range of values.

The method of any preceding clause, further comprising: determining whether cleaning of the component is complete based, at least in part, on the characteristic of the cleaning fluid effluent stream.

The method of any preceding clause, wherein the exposing step is performed using a device coupled to a borescope probe.

The method of any preceding clause, wherein the device comprises at least one of a delivery nozzle or a laser.

The method of any preceding clause, wherein the delivery nozzle is coupled to a delivery conduit associated with the borescope probe.

The method of any preceding clause, wherein the delivery conduit is coupled to a storage tank holding a heat transfer medium.

The method of any preceding clause, wherein the storage tank is disposed on a wash cart.

The method of any preceding clause, wherein at least one of a pump or a compressor is operatively coupled to the delivery conduit for delivering the heat transfer medium to the delivery nozzle.

The method of any preceding clause, wherein the at least one of the pump or the compressor is disposed on a wash cart.

The method of any preceding clause, wherein a temperature gradient is created between a top surface of the contaminant deposit and an interface between the contaminant deposit and the component within the transient thermal cycle.

The method of any preceding clause, wherein the temperature gradient induces a differential strain between the contaminant deposit and the component to facilitate detachment of the contaminant deposit from the component.

A method for cleaning a component of a gas turbine engine, the component disposed within an engine core, the gas turbine engine defining one or more access ports within the engine core, the method comprising: subjecting the component to a transient thermal cycle, the transient thermal cycle comprises exposing the component to a laser beam, wherein a surface temperature of the component changes by at least 373 degrees kelvin within a transient thermal cycle; and cleaning the component to remove at least a portion of a contaminant deposit from the component.

The method of any preceding claim, wherein a temperature gradient in the range of about 1,000K per millimeter to about 50,000K per millimeter within the contaminant deposit adjacent to the component is formed within the transient thermal cycle.

The method of any preceding claim, wherein the surface temperature of the component changes by a rate of at least 100,000 K per second within the transient thermal cycle.

The method of any preceding claim, wherein a temperature rise of the component within the transient thermal cycle is less than 473 K.

The method of any preceding claim, wherein the laser beam has a power in the range of 100 W to 10 kW.

The method of any preceding claim, wherein the laser beam induces internal stresses in the contaminant deposit adjacent to the component in the range of about 30 MPa to about 500 MPa around a circumference of a spot size of the laser beam.

The method of any preceding claim, wherein the laser beam induces a shear stress at an interface between the contaminant deposit and the component in the range of about 1 MPa to about 100 MPa.

The method of any preceding claim, wherein the laser beam has a pulse repetition frequency in the range of about 1 pulse per second to 50 pulses per second, and wherein the method further comprises adjusting an angle of the laser beam such that a portion of the contaminant deposit adjacent to the component exposed to the laser beam changes between pulses.

The method of any preceding claim, further comprising inserting a probe through one of the one or more access ports to expose the component to the laser beam, wherein the probe extends from a proximal end portion that is couped to a laser source to a distal end portion that focuses the laser beam on the component, the distal end portion of the probe include a lens for adjusting the laser beam and a mirror for directing the laser beam towards the component and a galvanometer operatively coupled to the mirror for adjusting an angle of the laser beam, and wherein the method further comprises adjusting the angle of the laser beam between thermal cycles or between pulses of the laser beam.

The method of any preceding clause, wherein a temperature gradient in the range of about 1,000 K per millimeter to about 50,000 K per millimeter within the contaminant deposit adjacent to the component is formed within the transient thermal cycle.

The method of any preceding clause, wherein the surface temperature of the component changes by at least about 100 K per second within the transient thermal cycle.

The method of any preceding clause, wherein a temperature rise of the component within the transient thermal cycle is less than 473 K.

The method of any preceding clause, wherein the surface temperature of the component changes at a rate of at least 100,000 K within the transient thermal cycle.

The method of any preceding clause, wherein the laser beam has a power in the range of 100 W to 10 kW.

The method of any preceding clause, wherein the laser beam has a spot size on a portion of the contaminant deposit adjacent to the component in the range of about 0.05 millimeter diameter to about 10 millimeter diameter.

The method of any preceding clause, wherein the laser beam induces internal stresses in the contaminant deposit adjacent to the component in the range of about 30 MPa to about 500 MPa around a circumference of a spot size of the laser beam.

The method of any preceding clause, wherein the laser beam induces a shear stress at an interface between the contaminant deposit and the component in the range of about 1 MPa to about 100 MPa.

The method of any preceding clause, wherein the laser beam has a pulse repetition frequency in the range of about 1 pulse per second to 50 pulses per second.

The method of any preceding clause, further comprising adjusting an angle of the laser beam such that a portion of the contaminant deposit adjacent to the component exposed to the laser beam changes between pulses.

The method of any preceding clause, further comprising inserting a probe through one of the one or more access ports to expose the component to the laser beam, wherein the probe extends from a proximal end portion that is couped to a laser source to a distal end portion that focuses the laser beam on the component, the distal end portion of the probe include a lens for adjusting the laser beam and a mirror for directing the laser beam towards the component.

The method of any preceding clause, wherein the probe further comprises a galvanometer operatively coupled to the mirror for adjusting an angle of the laser beam.

The method of any preceding clause, wherein the angle of the laser beam is adjusted between thermal cycles or between pulses of the laser beam.

The method of any preceding clause, wherein the engine core comprises a compressor section, a combustor section, and a turbine section, and wherein the method further comprises rotating one or more components of the compressor section or the turbine section of the gas turbine engine while exposing the component to the laser beam.

The method of any preceding clause, wherein a portion of the contaminant deposit adjacent to the component exposed to the laser beam changes as the one or more components of the compressor section or the turbine section of the gas turbine engine are rotated.

The method of any preceding clause, wherein cleaning the component to remove at least the portion of the contaminant deposit from the component comprises exposing the contaminant deposit and the component to acoustic waves from an acoustic source after the transient thermal cycle.

The method of any preceding clause, wherein cleaning the component comprises using a water wash system, a foam wash system, an abrasive media cleaning system, a dry ice blasting system, a frozen liquid media cleaning system.

The method of any preceding clause, wherein cleaning the component comprises at least one of vacuuming or brushing the component.

The method of any preceding clause, wherein the component is subjected to the transient thermal cycle when the gas turbine engine is shutdown.

A system for cleaning a component of a gas turbine engine, the component disposed within an engine core, the gas turbine engine defining one or more access ports within the engine core, the system comprising: a probe configured to be inserted through the one or more access ports; a device coupled to the probe for subjecting the component to two or more transient thermal cycles to remove at least a portion of a contaminant deposit from the component; wherein a surface temperature of the component changes by at least 293 degrees Kevin (K) within a transient thermal cycle.

The system of any preceding clause, wherein the device includes a delivery nozzle.

The system of any preceding clause, wherein the probe is coupled to a delivery conduit.

The system of any preceding clause, wherein the delivery conduit is coupled to a storage tank holding a heat transfer medium.

The system of any preceding clause, wherein the storage tank is disposed on a wash cart.

The system of any preceding clause, wherein at least one of the two or more transient thermal cycle comprises a cold cycle.

The system of any preceding clause, wherein at least one of the two or more transient thermal cycle comprises a hot cycle.

The system of any preceding clause, wherein the engine core is at an initial temperature in the range of about 313 K to about 333 K.

The system of any preceding clause, wherein the probe extends from a proximal end portion that is couped to a laser source to a distal end portion that focuses a laser beam on the component.

The system of any preceding clause, wherein the distal end portion of the probe includes a lens for adjusting the laser beam and a mirror for directing the laser beam towards the component.

The system of any preceding clause, further comprising a galvanometer operatively coupled to the mirror for adjusting an angle of the laser beam, and wherein the method further comprises adjusting the angle of the laser beam between thermal cycles or between pulses of the laser beam.

The system of any preceding clause, further comprising an acoustic source coupled to the probe.

A tangible computer-readable, non-transitory storage medium storing instructions that, when executed by a hardware processor associated with an aircraft, causes the hardware processor to execute a method comprising, receiving, from a sensor of a laser assembly, optical data indicative of a condition of a component of a gas turbine engine with a contaminant deposit formed thereon; and determining a number of transient thermal cycles for the component of the gas turbine engine based on the optical data.

The tangible computer-readable, non-transitory storage medium of any preceding clause, further comprising determining whether cleaning of the component is complete based on the optical data.

The tangible computer-readable, non-transitory storage medium of any preceding clause, further comprising adjusting a parameter of the laser assembly based on the optical data.

The tangible computer-readable, non-transitory storage medium of any preceding clause, wherein the parameter include a power, a pulse repetition frequency, or a spot size of a laser beam of the laser source assembly.

The tangible computer-readable, non-transitory storage medium of any preceding clause, wherein the sensor includes a back-scattered optical detector, optical sensor, an acoustic sensor, an ultrasonic sensor, charge-coupled device (CCD) camera, or an infrared (IR) camera.

The tangible computer-readable, non-transitory storage medium of any preceding clause, wherein

A system for cleaning a component of a gas turbine engine, the component disposed within an engine core, the gas turbine engine defining one or more access ports within the engine core, the system comprising: a probe configured to be inserted through the one or more access ports; a device coupled to the probe, the device configured to expose the component to at least one of a thermal energy source or a cooling medium; and a controller in operative communication with the device, the controller configured to adjust one or more operating parameters of the device to subject the component to two or more one transient thermal cycle to remove at least a portion of a contaminant deposit from the component.

The system of any preceding clause, wherein the controller is in operative communication with the probe, wherein the controller is configured to adjust a position of the probe relative to the component.

The system of any preceding clause, wherein the system further comprises a sensor and the controller is in operative communication from the sensor, and wherein the controller is further configured to receive data from the sensor.

The system of any preceding clause, wherein the data is indicative of a characteristic of the contaminant deposit, and wherein the controller is configured to adjust a position of the probe relative to the component based on the data.

The system of any preceding clause, wherein the data is indicative of a characteristic of the contaminant deposit, and wherein the controller is configured to adjust an operating parameter of the device based on the data.

A system for cleaning a component of a gas turbine engine, the component disposed within an engine core, the gas turbine engine defining one or more access ports within the engine core, the system comprising: a first probe configured to be inserted through the one or more access ports; a first device coupled to the probe, the first device configured to expose the component to a thermal energy source; a second probe configured to be inserted through the one or more access ports; a second device coupled to the second probe, the second device configured to expose the component to a cooling medium; and a controller in operative communication with the first device and the second device, the controller configured to adjust one or more operating parameters of the first device and the second device to subject the component to two or more one transient thermal cycle to remove at least a portion of a contaminant deposit from the component.

The system of any preceding clause, wherein the first device includes at least one of an induction coil, a laser, or a delivery nozzle in fluid communication with a source of a fluid medium.

The system of any preceding clause, wherein the second device includes a delivery nozzle in fluid communication with a source of a fluid medium.

What is claimed is:

1. A method for cleaning a component of a gas turbine engine, the component disposed within an engine core, the gas turbine engine defining one or more access ports within the engine core, the method comprising:
subjecting the component to two or more transient thermal cycles, wherein a surface temperature of the component changes by at least 293 degrees kelvin (K) within a transient thermal cycle; and
cleaning the component to remove at least a portion of a contaminant deposit from the component.

2. The method of claim 1, wherein a surface temperature of the component changes by a rate of at least about 100 K per second within at least one of the two or more transient thermal cycles.

3. The method of claim 1, wherein at least one of the two or more transient thermal cycles comprises a cold cycle.

4. The method of claim 3, wherein the cold cycle comprises exposing the component to a cooling medium, wherein the cooling medium is at a temperature in the range of about 77 K to about 300 K.

5. The method of claim 4, wherein the cooling medium comprises at least one of cold air, water, ice, dry ice, liquid nitrogen, or a refrigerant coolant.

6. The method of claim 1, wherein at least one of the two or more transient thermal cycles comprises a hot cycle.

7. The method of claim 6, wherein the hot cycle comprises exposing the component to a thermal energy source, and wherein the thermal energy source is at a temperature in the range of about 323 K to about 1,000 K.

8. The method of claim 7, wherein the thermal energy source comprises at least one of hot air, hot water, steam, or a laser.

9. The method of claim 7, wherein the thermal energy source comprises a laser, wherein the laser comprises a laser assembly including a probe for directing a laser beam to a target, the probe extends from a proximal end portion that is coupled to a laser source to a distal end portion that focuses the laser on the target, the distal end portion of the probe including a lens for adjusting the laser beam and a mirror for directing the laser beam towards the target.

10. The method of claim 1, wherein cleaning the component comprises directing a cleaning fluid into the engine core via the one or more access ports, and wherein the method further comprises:
determining a characteristic of a cleaning fluid effluent stream, the cleaning fluid effluent stream comprising at least a portion of the cleaning fluid that exits the engine core following the cleaning step; and
determining a number of additional transient thermal cycles for the component of the gas turbine engine based, at least in part, on the characteristic of the cleaning fluid effluent stream.

11. The method of claim 10, wherein cleaning the component to remove at least the portion of the contaminant deposit from the component comprises exposing the contaminant deposit and the component to acoustic waves from an acoustic source after the two or more transient thermal cycles.

12. A method for cleaning a component of a gas turbine engine, the component disposed within an engine core, the gas turbine engine defining one or more access ports within the engine core, the method comprising:
subjecting the component to a transient thermal cycle, the transient thermal cycle comprises exposing the component to a laser beam, wherein a surface temperature of the component changes by at least 373 degrees kelvin (K) within the transient thermal cycle; and
cleaning the component to remove at least a portion of a contaminant deposit from the component.

13. The method of claim 12, wherein a temperature gradient in the range of about 1,000 K per millimeter to about 50000 K per millimeter within the contaminant deposit adjacent to the component is formed within the transient thermal cycle.

14. The method of claim 12, wherein the surface temperature of the component changes by a rate of at least 100,000 K per second within the transient thermal cycle.

15. The method of claim 12, wherein a temperature rise of the component within the transient thermal cycle is less than 473 K.

16. The method of claim 12, wherein the laser beam has a power in the range of 100 W to 10 kW.

17. The method of claim 12, wherein the laser beam induces internal stresses in the contaminant deposit adjacent to the component in the range of about 30 MPa to about 500 MPa around a circumference of a spot size of the laser beam.

18. The method of claim 12, wherein the laser beam induces a shear stress at an interface between the contaminant deposit and the component in the range of about 1 MPa to about 100 MPa.

19. The method of claim 12, wherein the laser beam has a pulse repetition frequency in the range of about 1 pulse per second to 50 pulses per second, and wherein the method further comprises adjusting an angle of the laser beam such that a portion of the contaminant deposit adjacent to the component exposed to the laser beam changes between pulses.

20. The method of claim 12, further comprising inserting a probe through one of the one or more access ports to expose the component to the laser beam, wherein the probe extends from a proximal end portion that is couped to a laser source to a distal end portion that focuses the laser beam on the component, the distal end portion of the probe include a lens for adjusting the laser beam and a mirror for directing the laser beam towards the component and a galvanometer operatively coupled to the mirror for adjusting an angle of the laser beam, and wherein the method further comprises adjusting the angle of the laser beam between thermal cycles or between pulses of the laser beam.
